(19) United States
(12) Patent Application Publication
(10) Pub. No.: US 2021/0254390 A1
(43) Pub. Date: Aug. 19, 2021

(54) VEHICLE DOOR CONTROL DEVICE

(71) Applicant: AISIN SEIKI KABUSHIKI KAISHA, Kariya-shi (JP)

(72) Inventors: Takeshi KUWABARA, Kariya-shi (JP); Ryu MIYASHIRO, Kariya-shi (JP)

(73) Assignee: AISIN SEIKI KABUSHIKI KAISHA, Kariya-shi (JP)

(21) Appl. No.: 17/166,114

(22) Filed: Feb. 3, 2021

(30) Foreign Application Priority Data
Feb. 19, 2020 (JP) 2020-026092

(51) Int. Cl. E05F 15/70; B60J 5/04; E05F 15/622

(52) U.S. Cl. CPC E05F 15/70; B60J 5/04; E05F 15/622; E05Y 2201/246; E05Y 2900/531; E05Y 2201/70; E05Y 2201/702; E05Y 2400/302; E05Y 2201/434

(57) ABSTRACT

A vehicle door control device applied to a vehicle including a swingably supported door and a door braking unit applying a braking force to the door includes: a braking control unit that executes a first braking processing of holding the braking force at a reference braking force for stopping the door and ending when an external force acting on the door is larger than the braking force, and a second braking processing of gradually increasing the braking force from the reference braking force after the first braking processing. The braking control unit executes, during execution of the second braking processing, a processing of eliminating the braking force when a situation where the external force is larger than the braking force continues, and executes a third braking processing of holding the braking force to be equal to or larger than the reference braking force when the situation does not continue.

### CROSS REFERENCE TO RELATED APPLICATIONS

This application is based on and claims priority under 35 U.S.C. § 119 to Japanese Patent Application 2020-026092, filed on Feb. 19, 2020, the entire content of which is incorporated herein by reference.

### TECHNICAL FIELD

This disclosure relates to a vehicle door control device.

### BACKGROUND DISCUSSION

JP 2005-256423A (Reference 1) describes a vehicle including a vehicle body having a door opening portion, a door swingably supported by the vehicle body, a door driving unit that drives the door, and a door control device that controls the door driving unit. The door drive device includes a door drive motor serving as a drive source for opening and closing the door, a speed reduction mechanism that reduces a rotational speed of the door drive motor, and a clutch that connects and disconnects a power transmission path between the door drive motor and the speed reduction mechanism.

The door control device drives the door drive motor in a state in which the clutch is connected, and thereby opens and closes the door. The door control device stops the door drive motor in a state in which the clutch is connected, and thereby applies a braking force corresponding to a speed reduction ratio of the speed reduction mechanism to the door. The door control device eliminates the braking force applied to the door by disconnecting the clutch. In this case, a user can manually open and close the door.

In a situation in which the door is opened to an arbitrary position, a disturbance such as wind may act on the door. Therefore, it is preferable to apply a braking force to the door in order to prevent an unintended operation of the door. However, when the braking force is applied to the door, the door may not operate when the user manually operates the door opened to the arbitrary position.

A need thus exists for a vehicle door control device which is not susceptible to the drawback mentioned above.

### SUMMARY

Hereinafter, a method for solving the above-described problem and operation effects thereof will be described.

A vehicle door control device that solves the above-described problem is configured to be applied to a vehicle including a door that is swingably supported and a door braking unit that applies a braking force to the door. The vehicle door control device includes a braking control unit configured to execute a first braking processing of holding the braking force at a reference braking force for stopping the door and ending when an external force acting on the door is larger than the braking force, and a second braking processing of gradually increasing the braking force from the reference braking force after the first braking processing. The braking control unit executes, during execution of the second braking processing, a braking force eliminating processing of eliminating the braking force when a situation in which the external force is larger than the braking force continues, and executes a third braking processing of holding the braking force to be equal to or larger than the reference braking force when the situation in which the external force is larger than the braking force does not continue.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view showing a schematic configuration of a vehicle including a door control device;

FIG. 2 is a perspective view showing a schematic configuration in the periphery of a door of the above-described vehicle;

FIG. 3 is a schematic diagram showing a schematic configuration of a door driving unit of the above-described vehicle;

FIG. 4 is a flowchart showing a flow of a processing executed by the above-described door control device to adjust a braking force applied to the door; and

FIG. 5 is a timing chart showing a change in the braking force applied to the door when an external force acts on the door.

### DETAILED DESCRIPTION

Hereinafter, an embodiment of a vehicle including a vehicle door control device (hereinafter, also referred to as a “door control device”) will be described with reference to the drawings.

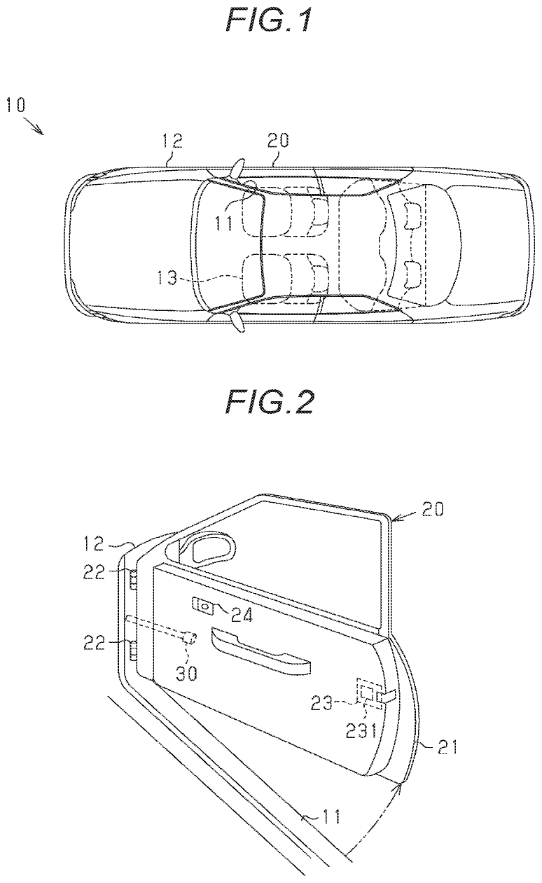

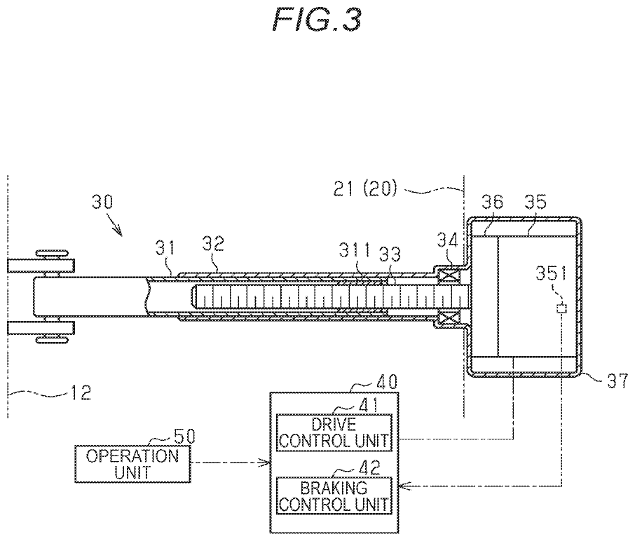

As shown in FIGS. 1 and 2, a vehicle 10 includes a vehicle body 12 including a door opening portion 11 on a side surface, seats 13 disposed inside the vehicle 10, a door 20 that opens and closes the door opening portion 11, and a door driving unit 30 that drives the door 20. As shown in FIG. 3, the vehicle 10 includes a door control device 40 that controls the door driving unit 30, and an operation unit 50 that is operated by a user when opening and closing the door 20.

As shown in FIG. 2, the door 20 includes a door main body 21, door hinges 22 that swingably couples the vehicle body 12 and the door main body 21, a door lock device 23 that restrains the door main body 21 to the vehicle body 12, and an inside door handle 24 that is operated by an occupant when releasing the restraint of the door lock device 23.

A front end portion of the door main body 21 is swingably supported by the vehicle body 12 via the door hinges 22. The door main body 21 swings between a fully closed position at which the door opening portion 11 is fully closed and a fully opened position at which the door opening portion 11 is fully opened about a swing axis line extending in a height direction of the vehicle 10. That is, the door 20 according to the present embodiment is a so-called swing door.

The door lock device 23 includes a latch mechanism 231 that switches between a locked state in which the door main body 21 positioned at the fully closed position is restrained to the vehicle body 12 and an unlocked state in which the door main body 21 positioned at the fully closed position is released from the restraint to the vehicle body 12. When the user operates the inside door handle 24, the latch mechanism 231 shifts from the locked state to the unlocked state. As a result, the door 20 may swing in an opening direction from the fully closed position.

As shown in FIG. 3, the door driving unit 30 includes an inner tube 31 having a first end swingably coupled to the door 20, an outer tube 32 into which a second end of the inner tube 31 is inserted, and a spindle screw 33 disposed inside the outer tube 32. The door driving unit 30 further includes a bearing 34 that rotatably supports the spindle screw 33, a motor 35 that drives the spindle screw 33, a speed reducing device 36 that transmits power of the motor 35 to the spindle screw 33, and a housing 37 that accommodates the motor 35 and the speed reducing device 36 and is fixed to the door 20.

The inner tube 31 and the outer tube 32 have a tubular shape. The swing axis line of the inner tube 31 relative to the vehicle body 12 extends in the same direction as the swing axis line of the door 20 relative to the vehicle body 12. The inner tube 31 includes a spindle nut 311 screwed with the spindle screw 33. The spindle nut 311 is fixed inside the inner tube 31 and near the second end of the inner tube 31. An outer diameter of the inner tube 31 is slightly smaller than an inner diameter of the outer tube 32, and the inner tube 31 can move in an axial direction relative to the outer tube 32. The outer tube 32 holds the bearing 34 on an inner side near a base end.

The spindle screw 33 constitutes a so-called feed screw mechanism together with the spindle nut 311. When the spindle screw 33 rotates, the spindle nut 311 moves in the axial direction relative to the spindle screw 33. That is, when the spindle screw 33 rotates, the inner tube 31 moves forward and backward relative to the outer tube 32 in accordance with a rotation direction of the spindle screw 33. On the other hand, when the inner tube 31 moves forward and backward relative to the outer tube 32, the spindle screw 33 rotates relative to the spindle nut 311.

In this way, the above-described feed screw mechanism converts a rotational motion of the spindle screw 33 into a reciprocating motion of the inner tube 31 relative to the outer tube 32, and converts the reciprocating motion of the inner tube 31 relative to the outer tube 32 into the rotational motion of the spindle screw 33.

The motor 35 is a brushless motor. The motor 35 includes a rotation angle sensor 351 such as a Hall element that detects a position of the rotor. An output shaft of the motor 35 is coupled to the speed reducing device 36.

In this way, the door driving unit 30 extends and contracts the inner tube 31 and the outer tube 32 by rotating the spindle screw 33 by driving the motor 35. When the inner tube 31 and the outer tube 32 extend, a load in the opening direction acts on the door 20 and the door 20 opens. On the other hand, when the inner tube 31 and the outer tube 32 contract, a load in a closing direction acts on the door 20 and the door 20 opens.

The speed reducing device 36 of the present embodiment has a speed reduction ratio set to a relatively small value. In this regard, if no current flows through a coil of the motor 35, the user can manually open and close the door 20. In other words, the door 20 according to the present embodiment can be electrically opened and closed by the door driving unit 30, or the user can manually open and close the door 20. The door driving unit 30 may include a clutch that disconnects or connects a power transmission path between the spindle screw 33 and the speed reducing device 36. Accordingly, a force when the user manually operates the door 20 is reduced.

Next, the door control device 40 will be described.

As shown in FIG. 3, the door control device 40 includes a drive control unit 41 that applies a driving force for opening and closing the door 20 to the door 20 by controlling the door driving unit 30. Specifically, the drive control unit 41 rotates the spindle screw 33 by sequentially switching a coil through which a current flows among three-phase coils of the motor 35 and a direction of the current flowing through the coil. The drive control unit 41 controls the door driving unit 30 based on signals input from the operation unit 50, specifically, an opening operation signal for opening the door 20, a closing operation signal for closing the door 20, and a stop signal for stopping the door 20.

As shown in FIG. 3, the door control device 40 includes a braking control unit 42 that applies a braking force to the door 20 to stop the door 20 at an arbitrary position by controlling the door driving unit 30. When applying the braking force to the door 20, the braking control unit 42 restricts the rotation of the spindle screw 33 by maintaining a state in which only a specific coil among the three-phase coils of the motor 35 is energized to the door driving unit 30. The braking control unit 42 changes the braking force applied to the door 20 by changing the magnitude of the current value flowing through the specific coil. In this regard, the door driving unit 30 according to the present embodiment is also a “door braking unit” that applies a braking force to the door 20.

Specifically, when the door 20 is stopped at an arbitrary position, the braking control unit 42 executes a first braking processing of holding the braking force applied to the door 20 for a reference braking force BPS for stopping the door 20. The reference braking force BPS is a force required to hold the door 20 at an arbitrary position so that the door 20 does not perform an operation unintended by the user. The reference braking force BPS may be varied in accordance with a gradient of a road surface on which the vehicle 10 is stopped.

Here, the user may manually open and close the door 20 while the braking control unit 42 executes the first braking processing. Therefore, when the user operates the door 20 during the execution of the first braking processing, the braking control unit 42 preferably quickly eliminates the braking force applied to the door 20. However, when the braking control unit 42 eliminates the braking force applied to the door 20 under non-condition during the execution of the first braking processing, the braking force applied to the door 20 may be eliminated even when an external force based on disturbance such as wind acts on the door 20. In this case, the door 20 may perform an operation unintended by the user.

For this reason, it is preferable that the braking control unit 42 eliminates the braking force when the user operates the door 20 during the execution of the first braking processing, and does not eliminate the braking force when the external force based on the disturbance acts on the door 20. In other words, it is preferable that the braking control unit 42 accurately determines whether the external force acting on the door 20 is caused by the user or the disturbance during the execution of the first braking processing.

When the external force acting on the door 20 during the execution of the first braking processing is equal to or greater than the reference braking force BPS, the braking control unit 42 ends the first braking processing and executes a second braking processing of increasing the braking force from the reference braking force BPS gradually. In the second braking processing, the braking control unit 42 may increase the braking force applied to the door 20 in a stepwise manner, or may increase the braking force applied to the door 20 in a linear manner.

When the user opens and closes the door 20 that is stopped, the user tends to increase the force for operating the door 20 gradually until the door 20 starts to open and close since a purpose of the user is to open and close the door 20. In this case, even when the braking force is increased gradually during the execution of the second braking processing, a state in which a force exceeding the braking force acts on the door 20 tends to continue.

Therefore, when a situation in which the external force acting on the door 20 is larger than the braking force continues during the execution of the second braking processing, the braking control unit 42 executes a braking force eliminating processing of eliminating the braking force. Specifically, the braking control unit 42 executes the braking force eliminating processing when the situation in which the external force acting on the door 20 is larger than the braking force becomes for a predetermined determination period Tth or longer during the execution of the second braking processing.

In this way, when the user operates the door 20, the braking control unit 42 executes the braking force eliminating processing instead of the second braking processing to shift the door 20 from a state in which the door 20 cannot be opened and closed to a state in which the door 20 can be opened and closed. The braking control unit 42 gradually reduces the braking force to “0” in the braking force eliminating processing. Here, when time until the braking force is set to “0” is long, the user cannot open or close the door 20 at an early stage, and when the time until the braking force is set to “0” is short, the door 20 operated by the user may suddenly operate. Therefore, the braking control unit 42 sets a decrease gradient of the braking force to a value that does not deviate from a reference gradient set in advance. The reference gradient is a value for improving an operational feeling when the user operates the door 20.

On the other hand, when the disturbance such as wind acts on the door 20, an external force applied to the door 20 tends to unregularly increase and decrease. In this case, when the braking force is increased gradually during the execution of the second braking processing, the state in which the external force exceeding the braking force acts on the door 20 tends to not continue.

Therefore, when the situation in which the external force acting on the door 20 is larger than the braking force does not continue during the execution of the second braking processing, the braking control unit 42 executes a third braking processing of holding the braking force to be equal to or larger than the reference braking force BPS.

In this way, when the disturbance acts on the door 20, the braking control unit 42 executes the third braking processing instead of the second braking processing, thereby maintaining the state in which the door 20 cannot be opened and closed. In the third braking processing, the braking control unit 42 preferably reduces the braking force, which has been increased to be larger than the reference braking force BPS, to the reference braking force BPS gradually.

When the determination period Tth is too short, it is difficult to distinguish the operation of the user from the disturbance, and when the determination period Tth is too long, the time during which the door 20 cannot be opened and closed even though the user wants to open and close the door 20 becomes long. Therefore, it is preferable that the determination period Tth is set to an appropriate value based on an experiment or the like in advance.

When the disturbance such as a strong wind acts on the door 20, a state may continue in which the external force exceeding the braking force acts on the door 20 during the execution of the second braking processing. However, the external force based on the disturbance such as a strong wind tends to increase in a short period as compared with the force with which the user operates the door 20. When the increment of the external force per unit time is small during the execution of the second braking processing, the braking control unit 42 executes the braking force eliminating processing, and when the increment of the external force per unit time is large, the third braking processing is executed.

In the present embodiment, the braking control unit 42 determines that the external force acting on the door 20 when a rotation amount of the motor 35 increases is larger than the braking force during the execution of the first braking processing and the second braking processing based on a detection signal from the rotation angle sensor 351. On the other hand, during the execution of the second braking processing, the braking control unit 42 determines that the external force acting on the door 20 when the rotation amount of the motor 35 is not increased is equal to or less than the braking force. In other words, the braking control unit 42 determines whether the external force acting on the door 20 is larger than the braking force depending on whether the door 20 is operating during the execution of the first braking processing and the second braking processing. However, an operation amount of the door 20 assumed here, in other words, the rotation amount of the motor 35, is assumed to be a slight amount.

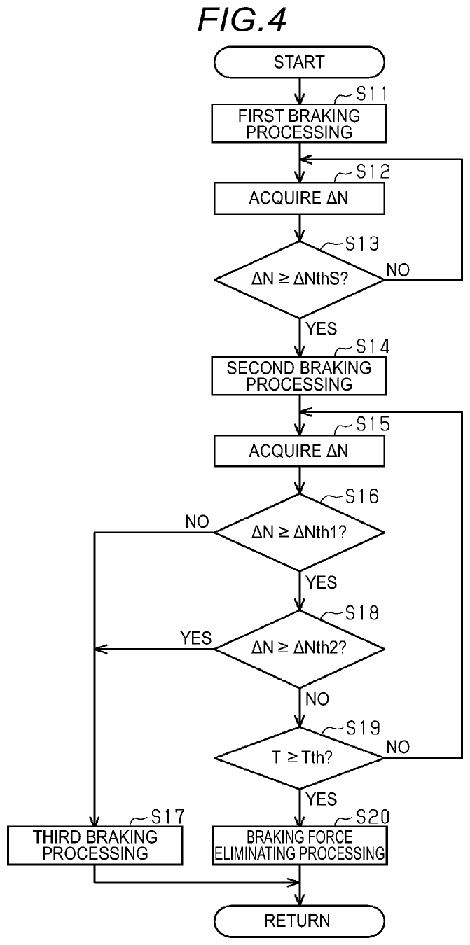

Hereinafter, a flow of a processing executed by the door control device 40 will be described with reference to a flowchart shown in FIG. 4. The door control device 40 executes the processing when the door 20 is opened to an arbitrary position. In other words, the door control device 40 executes the processing when a stop position of the door 20 is not the fully closed position.

As shown in FIG. 4, when the door 20 is stopped at an arbitrary position, the door control device 40 executes the first braking processing (S11). Then, the braking force applied to the door 20 is increased from “0” to the reference braking force BPS. Subsequently, the door control device 40 acquires an increment ΔN of the rotation angle of the motor 35 per unit time based on the detection signal from the rotation angle sensor 351 (S12). For example, the door control device 40 may execute a processing of acquiring the rotation angle of the motor 35 per unit time in parallel with the processing, and acquire the increment ΔN of the rotation angle of the motor 35 based on a difference between the rotation angle of the motor 35 at an execution timing of step S12 and the rotation angle of the motor 35 at a timing that is a unit time earlier than the execution timing.

Then, the door control device 40 determines whether the increment ΔN of the rotation angle of the motor 35 is equal to or larger than a start determination value ΔNthS indicating that the motor 35 has rotated (S13). When the increment ΔN of the rotation angle of the motor 35 is less than the start determination value ΔNthS (S13: NO), in other words, when the door 20 is not operated, the door control device 40 shifts the processing to step S12. On the other hand, for the door control device 40, when the increment ΔN of the rotation angle of the motor 35 is equal to or larger than the start determination value ΔNthS (S13: YES), that is, when the door 20 is slightly operated, the door control device 40 ends the first braking processing and executes the second braking processing (S14). That is, the braking force applied to the door 20 is increased from the reference braking force BPS gradually.

Subsequently, the door control device 40 acquires the increment ΔN of the rotation angle of the motor 35 per unit time based on the detection signal from the rotation angle sensor 351 (S15). In step S15, the door control device 40 may acquire the increment ΔN of the rotation angle of the motor 35 in a similar manner as in the previous step S12. Then, the door control device 40 determines whether the increment ΔN of the rotation angle of the motor 35 is equal to or larger than a lower limit determination value ΔNth1 indicating that the motor 35 is rotating (S16). When the increment ΔN of the rotation angle of the motor 35 is less than the lower limit determination value ΔNth1 (S16: NO), that is, when the door 20 is stopped due to the external force acting on the door 20 and being equal to or less than the braking force applied to the door 20, the door control device 40 executes the third braking processing instead of the second braking processing (S17). That is, the braking force applied to the door 20 is decreased to the reference braking force BPS. The lower limit determination value ΔNth1 may be a value equal to the start determination value ΔNthS. Thereafter, the door control device 40 ends the processing.

On the other hand, when the increment ΔN of the rotation angle of the motor 35 is more than the lower limit determination value ΔNth1 (S16: YES), that is, when the door 20 is operated due to the external force acting on the door 20 and being larger than the braking force applied to the door 20, the door control device 40 executes the next processing of step S18. That is, the door control device 40 determines whether the increment ΔN of the rotation angle of the motor 35 is equal to or larger than an upper limit determination value ΔNth2 indicating that the motor 35 is exceedingly rotating (S18).

When the increment ΔN of the rotation angle of the motor 35 is more than the upper limit determination value ΔNth2 (S18: YES), that is, when the door 20 is largely operated due to the external force acting on the door 20 largely exceeding the braking force applied to the door 20, the door control device 40 shifts the processing to step S17. The upper limit determination value ΔNth2 is a value larger than the lower limit determination value ΔNth1.

On the other hand, when the increment ΔN of the rotation angle of the motor 35 is less than the upper limit determination value ΔNth2 (S18: NO), that is, when the external force acting on the door 20 slightly exceeds the braking force applied to the door 20, the door control device 40 determines whether an elapsed time T from the start of the execution of the second braking processing is equal to or longer than the determination period Tth (S19). When the elapsed time T is less than the determination period Tth (S19: NO), the door control device 40 shifts the processing to step S15. On the other hand, when the elapsed time T is equal to or longer than the determination period Tth (S19: YES), the door control device 40 performs a braking force eliminating processing (S20). In this case, the braking force applied to the door 20 is reduced gradually as the braking force becomes “0”.

In the present embodiment, the start determination value ΔNthS, the lower limit determination value ΔNth1, and the upper limit determination value ΔNth2 are preferably determined in advance, for example, based on characteristics of the vehicle 10 such as the size of the door 20 and a distance from the swing axis line of the door 20 to a position operated by the user when opening and closing the door 20. The determination value may be a variable value according to a situation in which the vehicle 10 is stopped, such as a gradient of a road surface on which the vehicle 10 is stopped.

Next, operation of the present embodiment will be described.

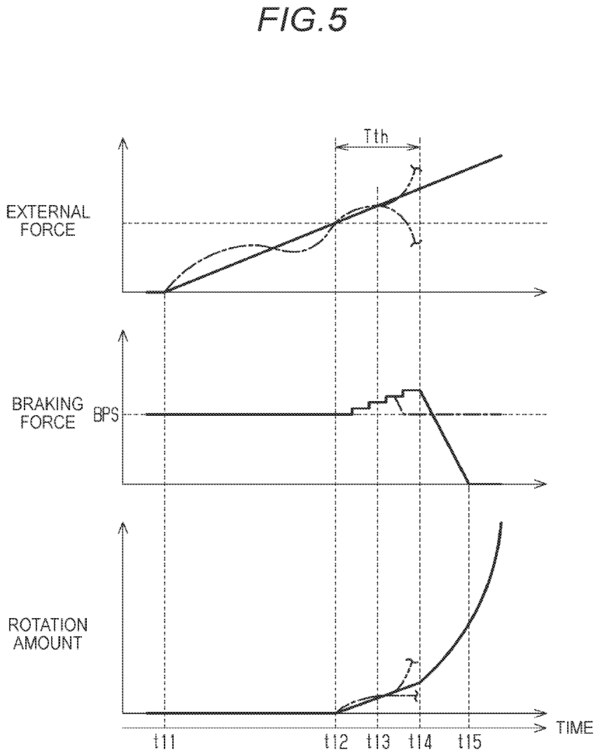

Specifically, with reference to the timing chart shown in FIG. 5, a transition of the braking force when the external force based on the operation of the user and the external force based on the disturbance act on the door 20 will be described. In FIG. 5, the rotation amount of the motor 35 indirectly indicates the operation amount of the door 20 from a first timing t11 since the rotation amount of the motor 35 indicates the increase amount of the rotation amount of the motor 35 from the first timing t11.

First, a case in which the user manually operates the door 20 to be stopped will be described.

As indicated by a solid line in FIG. 5, in a period until the first timing t11, the braking force applied to the door 20 is held at the reference braking force BPS, and the rotation of the motor 35 is stopped. That is, the first braking processing is performed, and the door 20 is stopped. Then, when the user starts to operate the door 20 at the first timing t11, the external force based on the operation of the user increases after the first timing t11.

At the second timing t12, when the external force based on the operation of the user becomes larger than the reference braking force BPS, the motor 35 starts to rotate slightly. Therefore, at the second timing t12, the first braking processing is ended, and the second braking processing is started. As a result, after the second timing t12, the braking force applied to the door 20 increases from the reference braking force BPS gradually.

Thereafter, in a period from a second timing t12 to a fourth timing t14 at which the determination period Tth elapses, a state in which the external force based on the operation of the user is larger than the braking force continues, and the rotation amount of the motor 35 continues to increase. Specifically, during the determination period Tth from the second timing t12 to the fourth timing t14, a state continues in which the increment ΔN of the rotation amount of the motor 35 in each predetermined cycle is equal to or larger than the lower limit determination value ΔNth1 and less than the upper limit determination value ΔNth2. During the determination period Tth, the door 20 operates only slightly because the difference between the external force based on the operation of the user and the braking force applied to the door 20 is small.

At the fourth timing t14 at which the determination period Tth elapses, the second braking processing is ended, and the braking force eliminating processing is started. That is, after the fourth timing t14, the braking force applied to the door 20 is eliminated. Accordingly, after a fifth timing t15 at which the braking force applied to the door 20 becomes “0”, the door 20 operates at a speed desired by the user based on the force with which the user operates the door 20.

Next, a case in which the disturbance such as wind acts on the stopped door 20 will be described.

As indicated by a one-dot chain line and a two-dot chain line in FIG. 5, the external force based on the disturbance tends to increase and decrease compared with the external force based on the operation of the user. As indicated by the one-dot chain line in FIG. 5, at a third timing t13 at which the external force based on the disturbance is larger than the braking force applied to the door 20, the first braking processing is ended, and the second braking processing is started. At the third timing t13 in the determination period Tth, as indicated by the one-dot chain line, when the external force based on the disturbance decreases due to such a reason that the wind suddenly weakens, the external force acting on the door 20 is less than the braking force. Then, the rotation speed of the motor 35 decreases, and the increment ΔN of the rotation amount of the motor 35 is less than the lower limit determination value ΔNth1. As a result, at a timing after the third timing t13, the second braking processing is ended and the third braking processing is started. That is, in a case in which the external force based on the disturbance acts on the door 20, the operation of the door 20 based on the disturbance is prevented since the braking force eliminating processing is not started.

On the other hand, at the third timing t13 in the determination period Tth, as indicated by the two-dot chain line, when the external force based on the disturbance increases due to such a reason that the wind suddenly become strong, a difference between the external force acting on the door 20 and the braking force increases. Then, the rotation speed of the motor 35 increases, and the increment ΔN of the rotation amount of the motor 35 is equal to or larger than the upper limit determination value ΔNth2. As a result, at a timing after the third timing t13, the second braking processing is ended and the third braking processing is started. That is, as in the case indicated by the one-dot chain line, the braking force is held at the reference braking force BPS or more. In this way, in a case in which the external force based on the disturbance acts on the door 20, the operation of the door 20 based on the disturbance is prevented since the braking force eliminating processing is not started.

Next, effects of the present embodiment will be described.

(1) During the execution of the second braking processing, the door control device 40 determines whether the external force acting on the door 20 is based on the operation of the user based on whether a state in which the external force acting on the door 20 is larger than the braking force applied to the door 20 continues. In this way, the door control device 40 can distinguish the disturbance acting on the door 20 opened to the arbitrary position from the operation of the user.

(2) In the braking force eliminating processing, since the door control device 40 gradually reduces the braking force, a rapid opening and closing of the door 20 operated by the user can be prevented as compared with a case in which the braking force is rapidly reduced.

(3) When the increment ΔN of the rotation amount of the motor 35 is equal to or larger than the upper limit determination value ΔNth2 during the execution of the second braking processing, the door control device 40 executes the third braking processing. Therefore, the door control device 40 can prevent the door 20 from being switched to a state in which the door 20 can be opened and closed when a large external force due to the disturbance such as a strong wind acts on the door 20.

(4) The door control device 40 determines whether an external force larger than the braking force applied to the door 20 acts on the door 20 based on whether the rotation amount of the motor 35 increases during the execution of the second braking processing. Accordingly, the door driving unit 30 does not need a sensor for detecting the magnitude of the external force acting on the door 20.

The above embodiments can be implemented by modifications as follows. The present embodiment and the following modifications can be implemented in combination with each other in a scope without technical contradiction.
In the flowchart shown in FIG. 4, when the increment ΔN of the rotation amount of the motor 35 is less than the lower limit determination value ΔNth1, the door control device 40 may hold the braking force applied to the door 20 to the braking force applied to the door 20 at the timing when the increment ΔN of the rotation amount of the motor 35 is less than the lower limit determination value ΔNth1. Similarly, when the increment ΔN of the rotation amount of the motor 35 is equal to or more than the upper limit determination value ΔNth2, the door control device 40 may hold the braking force applied to the door 20 to the braking force applied to the door 20 at the timing when the increment ΔN of the rotation amount of the motor 35 is equal to or larger than the upper limit determination value ΔNth2. That is, the door control device 40 may appropriately change the braking force applied to the door 20 in the third braking processing.
When an external force based on the opening and closing operation of the user acts on the door 20, the rotational speed of the motor 35 in the determination period Tth tends to be maintained at a constant speed. On the other hand, when an external force based on the disturbance acts, the rotational speed of the motor 35 in the determination period Tth tends to increase and decrease. Therefore, the door control device 40 may determine whether the external force is based on the opening and closing operation of the user based on the transition of the rotation amount of the motor 35 in the determination period Tth. For example, when the variation in the rotation speed of the motor 35 in the determination period Tth is small, it may be determined that the external force is based on the opening and closing operation of the user, and when the variation in the rotation speed of the motor 35 in the determination period Tth is large, it may be determined that the external force is based on the disturbance.
The vehicle 10 may be provided with a door braking unit that applies a braking force to the door 20 separately from the door driving unit 30. The door braking unit may be, for example, an electromagnetic brake that generates a braking force in a direction opposite to the rotation direction of the spindle screw 33. In this case, a type of the motor 35 does not have to be the brushless motor.
The door driving unit 30 may have a load sensor that detects an external force applied to the door 20. In this case, the door control device 40 may determine whether the external force acting on the door 20 is based on the operation of the user or the disturbance based on a detection result of the load sensor.
The door driving unit 30 may be configured to open and close the door 20 by, for example, a mechanism such as a rack and pinion mechanism that converts rotational motion into linear motion.
The vehicle 10 may include an obstacle sensor that detects an obstacle present in a swing range of the door 20. In this case, it is preferable that the door control device 40 stops the door 20 before the door 20 comes into contact with the obstacle and executes the first braking processing in a situation in which the door 20 is opened.
The door control device 40 may be applied to, for example, control of a back door that opens and closes a door opening portion provided at a rear side of the vehicle body 12. That is, the door control device 40 may be applied to control a door extending in the direction in which the swing axis line intersects a vertical direction of the vehicle.
The door control device 40 may include one or more processors that operate according to a computer program (software), one or more dedicated hardware circuits such as dedicated hardware (application-specific integrated circuit: ASIC) that executes at least a part of various processing among various processings, or a circuit including a combination thereof. The processor includes a CPU and a memory such as an RAM and an ROM, and the memory stores program codes or instructions that cause the CPU to execute processing. The memory, that is, a storage medium, includes any available medium that can be accessed by a general-purpose computer or a dedicated computer.

A vehicle door control device that solves the above-described problem is configured to be applied to a vehicle including a door that is swingably supported and a door braking unit that applies a braking force to the door. The vehicle door control device includes a braking control unit configured to execute a first braking processing of holding the braking force at a reference braking force for stopping the door and ending when an external force acting on the door is larger than the braking force, and a second braking processing of gradually increasing the braking force from the reference braking force after the first braking processing. The braking control unit executes, during execution of the second braking processing, a braking force eliminating processing of eliminating the braking force when a situation in which the external force is larger than the braking force continues, and executes a third braking processing of holding the braking force to be equal to or larger than the reference braking force when the situation in which the external force is larger than the braking force does not continue.

When the user opens and closes the door that is stopped, the user tends to gradually increase a force for operating the door until the door starts to open and close since a purpose of the user is to open and close the door. In this case, even if the braking force is increased gradually during the execution of the second braking processing, a state in which a force exceeding the braking force acts on the door tends to continue. On the other hand, when a disturbance such as wind acts on the door, an external force applied to the door tends to unregularly increase and decrease. In this case, when the braking force is increased gradually during the execution of the second braking processing, the state in which the external force exceeding the braking force acts on the door tends to not continue.

In this way, when the user operates the door, the vehicle door control device executes the braking force eliminating processing to change a state of the door from a state in which the door cannot be opened and closed to a state in which the door can be opened and closed. On the other hand, when the disturbance acts on the door, the vehicle door control device maintains a state in which the door cannot be opened or closed by executing the third braking processing. Therefore, the vehicle door control device can distinguish the disturbance acting on the door from an operation of the user in a situation in which the braking force is applied to the door opened to the arbitrary position.

In the above-described vehicle door control device, it is preferable that the braking control unit gradually reduces the braking force in the braking force eliminating processing.

During execution of the braking force eliminating processing, since the vehicle door control device having the above-described configuration gradually reduces the braking force, a rapid opening and closing of the door based on the operation of the user can be prevented as compared with a case in which the braking force is rapidly reduced.

In the above-described vehicle door control device, it is preferable that during the execution of the second braking processing, in the situation in which the external force is larger than the braking force continues, the braking control unit executes the braking force eliminating processing when an increment of the external force per unit time is less than an upper limit determination value, and executes the third braking processing when the increment of the external force per unit time is equal to or larger than the upper limit determination value.

When the disturbance such as a strong wind acts on the door, the external force exceeding the braking force may continue to act on the door during the execution of the second braking processing. However, the external force based on the disturbance such as the strong wind tends to increase in a short period as compared with the force with which the user operates the door. In this regard, the vehicle door control device having the above-described configuration executes the third braking processing when the increment of the external force per unit time is equal to or larger than the upper limit determination value. Accordingly, the vehicle door control device can prevent the door from being switched to a state in which the door can be opened and closed when a disturbance such as a strong wind acts on the door.

It is preferable that the vehicle includes a door driving unit including a motor serving as a drive source that opens and closes the door, that the vehicle door control device further includes a drive control unit that opens and closes the door by controlling the door driving unit, and that, during execution of the first braking processing and the second braking processing, the braking control unit determines that the external force is larger than the braking force when a rotation amount of the motor increases and determines that the external force is equal to or smaller than the braking force when the rotation amount of the motor does not increase.

The vehicle door control device having the above-described configuration determines whether the external force is larger than the braking force based on whether the rotation amount of the motor increases. Therefore, it is not necessary to separately provide a sensor that detects a magnitude of the external force acting on the door.

The vehicle door control device can distinguish a disturbance acting on a door from an operation of the user in a situation in which a braking force is applied to the door opened to an arbitrary position.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door control device configured to be applied to a vehicle including a door that is swingably supported and a door braking unit that applies a braking force to the door, the vehicle door control device comprising:
a braking control unit configured to execute a first braking processing of holding the braking force at a reference braking force for stopping the door and ending when an external force acting on the door is larger than the braking force, and a second braking processing of gradually increasing the braking force from the reference braking force after the first braking processing, wherein
the braking control unit executes, during execution of the second braking processing, a braking force eliminating processing of eliminating the braking force when a situation in which the external force is larger than the braking force continues, and executes a third braking processing of holding the braking force to be equal to or larger than the reference braking force when the situation in which the external force is larger than the braking force does not continue.

2. The vehicle door control device according to claim 1, wherein
the braking control unit gradually reduces the braking force in the braking force eliminating processing.

3. The vehicle door control device according to claim 1, wherein
during the execution of the second braking processing, in the situation in which the external force is larger than the braking force continues, the braking control unit executes the braking force eliminating processing when an increment of the external force per unit time is less than an upper limit determination value, and executes the third braking processing when the increment of the external force per unit time is equal to or larger than the upper limit determination value.

4. The vehicle door control device according to claim 1, wherein
the vehicle includes a door driving unit including a motor serving as a drive source that opens and closes the door,
the vehicle door control device further comprises a drive control unit that opens and closes the door by controlling the door driving unit, and
during execution of the first braking processing and the second braking processing, the braking control unit determines that the external force is larger than the braking force when a rotation amount of the motor increases and determines that the external force is equal to or smaller than the braking force when the rotation amount of the motor does not increase.
